(19) United States
(12) Patent Application Publication
(10) Pub. No.: US 2013/0166619 A1
(43) Pub. Date: Jun. 27, 2013

(54) ACCESSING BUSINESS INTELLIGENCE WORKFLOWS

(71) Applicants: TIMOTHY THOMPSON, Burnaby (CA); HANSON Ho, Vancouver (CA)

(72) Inventors: TIMOTHY THOMPSON, Burnaby (CA); HANSON Ho, Vancouver (CA)

(21) Appl. No.: 13/335,985

(22) Filed: Dec. 23, 2011

(51) Int. Cl. G06F 15/16

(52) U.S. Cl. 709/201

(57) ABSTRACT

A request to access an action of a workflow from a number of business intelligence (BI) workflows in a computer system is received, where the action of the workflow is encoded. A generator encodes the action in generic syntax to identify and locate the action. The generator encodes the action of the workflow based on context parameters associated with the action. An interpreter interprets the encoded action of the workflow and processes the context parameters associated with the action. In response to the access request, the action of the workflow is launched.

### FIELD

Embodiments of the invention generally relate to the software arts, more specifically, to business intelligence workflows.

### BACKGROUND

Business Intelligence (BI) generally refers to a category of software systems and applications used to improve business enterprise decision-making and governance. These software tools provide techniques for analyzing and leveraging enterprise applications and data. BI tools are commonly applied to financial, human resource, marketing, sales, service provision, customer and supplier analyses. More specifically, these tools can include: reporting and analysis tools to analyze, forecast and present information, content delivery infrastructure systems for delivery, storage and management of reports and analytics, data warehousing systems for cleansing and consolidating information from disparate sources, and integration tools to analyze and generate processes based on enterprise systems. Examples of such BI systems and applications are part of SAP® BusinessObjects™ Business Intelligence platform provided by SAP AG.

Typically, access to a BI platform is enabled via a BI portal. Examples of such BI portals include Central Management Console (CMC) and BI Launch pad. Users access a BI portal to access, view, schedule, interact with, and export, any type of BI objects including reports, analytics, dashboards, scorecards, and strategy maps. Conventional BI portals are browser applications. From a BI portal users can access BI workflows and other functionality of the BI platform. Typically, such BI workflows require non-trivial user actions. For example, users have to log in to respective BI applications, adjust the BI workflows to conform to specific conditions, and manually navigate through the BI systems' graphical user interface to launch desired functionality. Furthermore, interaction of client applications or users with the BI platform may require a user session. In case the connection between client applications and the BI systems is terminated, access to various stages of the BI workflows from client applications of the BI systems would necessitate repetition of users' actions. Therefore, access to stages of the BI workflows from client applications may be complicated.

### SUMMARY

Various embodiments of systems and methods for accessing business intelligence workflows are described herein. In one aspect, a request to access an action of a workflow from a number of business intelligence (BI) workflows in a computer system is received, where the action of the workflow is encoded. According to one embodiment, the action of the workflow is encoded by a generator in generic syntax to identify and locate the action. Furthermore, the generator encodes the action of the workflow based on context parameters associated with the action. In a further aspect an interpreter interprets the encoded action of the workflow. The interpreter processes the context parameters associated with the action. In response to the access request, the action of the workflow is launched. In one aspect, a graphical user interface associated with the requested action is rendered.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates exemplary system architecture to enable access to BI workflows, according to one embodiment.

FIG. 2 illustrates a process for encoding an action of a BI workflow in a BI computer system, according to one embodiment.

FIG. 3 illustrates a process for interpreting an encoded action of a BI workflow in a BI computer system, according to one embodiment.

FIG. 4 illustrates exemplary system in a context of a BI platform, where access to BI workflows is enabled, according to one embodiment.

FIG. 5 is a diagram of an exemplary computer system, according to one embodiment.

### DETAILED DESCRIPTION

Embodiments of techniques for accessing business intelligence workflows are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A BI workflow may involve a multistep sequence of actions. A BI workflow may be a reusable sequence of actions with defined order of actions' execution. Information may be passed into or out of workflows using parameters. Examples of actions that may comprise BI workflows include, but are not limited to, view, schedule, modify, print, export, save, create, refresh, and any other interactions with BI documents or other BI objects. An action is part of a BI workflow. In one embodiment, a BI workflow may consist of a single action. Typically, actions may be enacted or launched by client applications or users. In one embodiment, examples of BI documents on which it can be acted upon include, but are not limited to, reports or report instances such as Crystal Reports or OLAP Intelligence report, Desktop Intelligence Documents, and Web Intelligence documents. Other exemplary documents that may be managed by BI workflows include, but are not limited to, Excel Spreadsheets, Power Point Presentations, Rich Text Format Documents, Text Files, documents in Adobe Portable Document Format, etc. In a further aspect, other BI entities on which it may be acted upon include, but are not limited to, analytics, dashboards, workspaces, strategy maps, scorecards, etc.

Typically, BI workflows require complex user behavior and are processed in the context of a user session. For example, a user may have to log into a BI portal, launch a scheduling workflow, and adjust the BI workflow to conform to specific conditions. Such specific conditions may be launching a BI workflow in response to a specific event or according to a predetermined time, e.g., schedule a report to run every day at 10:00 AM. BI content managed by BI workflows may be processed at predetermined times and delivered to specific users or user groups. Furthermore, BI content may be personalized based on intended recipients. Complex BI workflows require selection of various configuration settings, preferences and input parameters. Based on such parameters or configuration settings, users may perform analysis on the data. In an embodiment, for report objects, such parameters may determine what data appears in the report and what specific queries are executed over data sources to retrieve desired data. For example, a report may contain an “order date” parameter. Users may enter a range of dates as the parameter value, and the report only displays data about orders within the specified time range.

In one embodiment, access to complex and context-dependent BI workflows is enabled. Access to actions of BI workflows is enabled, where the manual navigation and context-gathering that typically would be necessary is bypassed. In one embodiment, the requested action of a BI workflow is encoded in generic syntax to identify and locate said workflow.

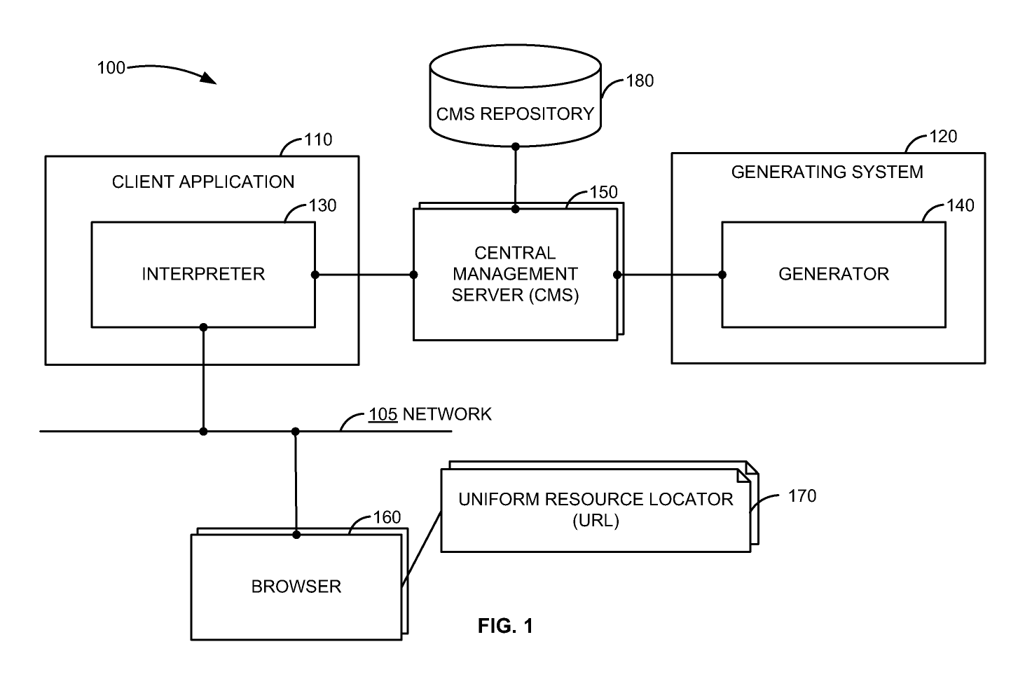

FIG. 1 illustrates exemplary system 100 to enable access to BI workflows in a BI computer system. In one embodiment, a request is received at a generator 140 to encode an action of a BI workflow. The generator 140 is a computer module that encodes BI workflows in generic syntax to identify and locate actions associated with the BI workflows. The syntax defines the primary access mechanism to a BI workflow in a computer system such as a BI platform. In one embodiment, the generator 140 encodes a requested workflow into a Uniform Resource Locator (URL) 170. In various embodiments, other formats or syntaxes may be used including, but not limited to, Uniform Resource Identifier (URI), Extensible Resource Identifier (XRI), Persistent Uniform Resource Locator (PURL), Resource Description Framework Format (RDF), etc. The generator 140 generates encoded BI workflow represented in generic syntax to express location, identification, preferences, and context parameters of the BI workflow. The generic syntax enables flexible reference of available BI workflows available in the BI system. The generic syntax may be used for any type of BI workflow and the type of the BI workflow may be included, for example, as a parameter in the URL 170 of the encoded BI workflow.

In one embodiment, an interpreter 130 receives request to interpret the encoded action associated with the BI workflow. Interpreter 130 is a computer module that interprets encoded BI workflows. Interpreter 130 processes the request and interprets the encoded BI workflow. In one embodiment, the interpreter 130 is included in client application 110. In response to the access request processed and interpreted by interpreter 130, client application 110 launches the requested BI workflow. In various embodiments, client application 110 may be a BI portal such as BI Launch pad, CMC or SAP® Knowledge Management and Collaboration (KMC) portal. Furthermore, interpreter 130 may be integrated in other web applications such as Life Cycle Manager (LCM), Monitoring, and Open Document part of SAP® BusinessObjects™ BI platform.

Various parameters are entered into generator 140 as input data. The requested BI workflow is encoded based on context parameters associated with the BI workflow. Examples of such parameters include, but are not limited to, an identifier of the action to be launched, an identifier of the BI object the action is to be launched against, context parameters associated with the action, user information such as logon data, configuration settings, etc. Context parameters represent the context in which the BI workflow is to be launched. The interpreter 130 parses and processes the input parameters included in URL 170. In one embodiment, based on the context parameters included in URL 170, client application 110 launches the requested action in a context associated with the action of the BI workflow.

In one embodiment, in response to the received access request, the interpreter 130 may query a Central Management Server (CMS) 150. CMS 150 coordinates and controls components that are included in SAP® BusinessObjects™ BI platform. The CMS maintains security and configuration information, sends service requests to other servers on the BI platform, manages auditing, etc. In other embodiments, other similar servers included in BI platforms provided by different vendors may be used. In one embodiment, CMS 150, in response to query requests retrieves data from CMS Repository 180. The CMS Repository 180 stores metadata of entities in the BI platform. Examples of entities in the BI platform for which metadata may be stored in CMS Repository 180 include, but are not limited to, BI objects, BI content, BI workflows, BI services, UI components, users, etc. Such metadata may be represented as information objects (also referred to as “infoObjects”).

According to one embodiment, an information object is a collection of one or more pieces of metadata. The metadata describes one or more aspects of a component in a system. In a BI system, the metadata is to a component object, another information object or aspect of a BI system. For example, metadata of a Crystal Report is stored in CMS Repository 180 contained by an information object of type “Crystal Report.” In one embodiment, the actual report may be stored in a file system, e.g., as an .rpt file. Similarly, information objects representing metadata for other BI documents may be stored in CMS Repository 180. For example, metadata for Web Intelligence Documents may be represented in an information object of type “Web Intelligence Document”, metadata for Desktop Intelligence Documents may be represented in an information object of type “Web Intelligence Document”, etc. In another aspect, information objects may describe other BI entities such as, universes, measures, dimensions, connections, etc. In a further aspect, information objects may also describe metadata for applications, users, users' groups, license keys, etc.

In one aspect, an information object is represented as a row in a table in a relational database. For example, information objects are stored in a database table retained in CMS Repository 180. In one embodiment, CMS Repository 180 is queried to retrieve and access stored information objects. Any query language may be used to retrieve information objects from CMS Repository 180 including Structured Query Language (SQL) or any type of database vendor query language. The information object can be implemented in binary or human readable format. In an embodiment, the information objects are implemented in eXtensible Markup Language (XML). In one embodiment, actions that are part of a workflow are performed on specific types of information objects. For example, a specific “view” action is implemented for Crystal Reports and another “view” action for Web Intelligence Documents. Furthermore, actions' metadata is also included in information objects. In one embodiment, an action is represented as information object that contains a URL. Based on the URL, a web page that implements the action may be located. An action would typically be represented by an information object, a Java class, and a Java Server Page (JSP) or other servlet.

In one embodiment, generating system 120 sends requests to generator 140 to encode BI workflows. In response to such requests, generator 140 generates one or more encoded BI workflows into one or more URLs (e.g., 170). In an embodiment, generating system 120 is a job server such as Adaptive Job Server (AJS) part of the SAP® BusinessObjects™ BI platform. In another embodiment, generating system 120 is a SAP® KMC Repository Manager also part of the SAP® BusinessObjects™ BI platform. Generating system 120 may invoke scheduling jobs (e.g., schedule a Crystal Report job). Generating system 120 may store and publish the jobs' results to an output location such as a file system of the BI computer system, electronic mails, users' inboxes, or any other persistent storage medium. An exemplary scenario may be that, in response to invoked scheduling job of a Crystal Report, generating system 120 sending a request to generator 140 to encode the scheduling job into URL 170. Generator 140 constructs requested URL 170. The generating system 120 may publish the constructed URL into an electronic mail. The mail with included URL 170 of the encoded scheduling BI workflow may be sent to a user to notify the user of the successfully scheduled report. In one embodiment, based on URL 170, the respective encoded BI workflow is launched by client application 110 in browser 160. For example, a scheduled report may be launched by BI launch pad and displayed in a browser window. In one embodiment, browser 160 is communicatively coupled to interpreter 130 through network 105, e.g. the Internet, intranet, or other public or private computer network.

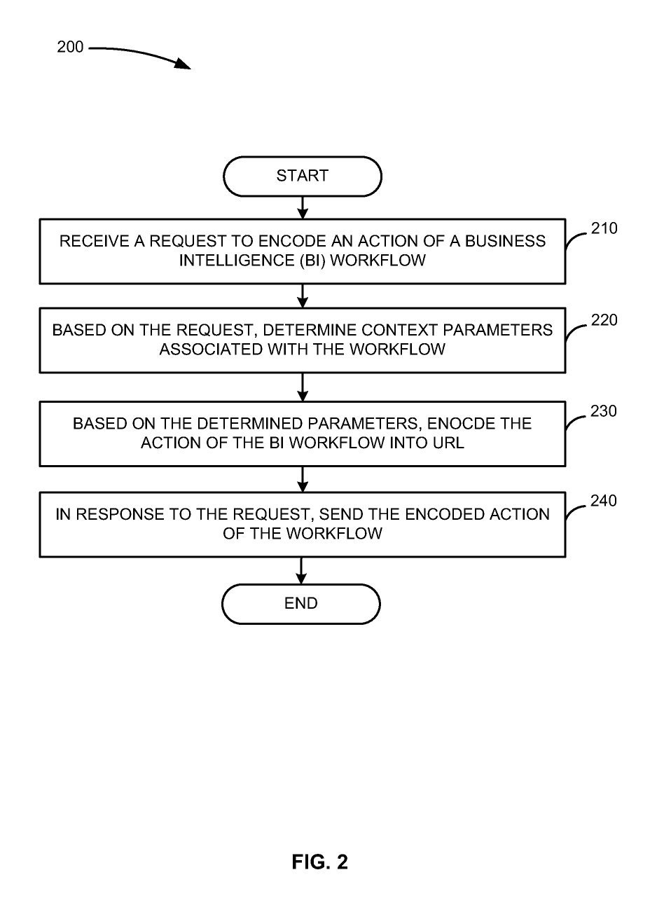

FIG. 2 illustrates a process 200 for encoding an action of a BI workflow in a BI computer system, according to one embodiment. At 210, a request to encode an action of a BI workflow is received. In one embodiment, the action of the BI workflow is to be encoded into URL. Rules may be specified in the request, where the URL of the encoded BI workflow is to conform to these rules. At 220, based on the request, context parameters associated with the BI workflow are determined. BI workflows may be encoded based on various parameters. In one aspect, an identifier or name of the action is determined. In addition, identifier or name of a target BI document the action is to be launched against is also determined. Information objects are identified by identification (ID) numbers. Thus, an identifier of the information object that represents the BI document and an identifier of the information object that represents the action may be determined. The following portion of an exemplary URL includes parameter that represents an identifier of a BI Document “openDocument.jsp?iDocID=342”, i.e., parameter “iDocID” with value “342”. In one embodiment, the path to the target BI document to be retrieved is also determined, e.g., names of the folders and subfolders containing the target BI document.

In another aspect, parameters that indicate user and system information are also determined such as user name, user's session token generated by a BI platform or other logon data, identifier of a server such as CMS identifier, etc. From another perspective, parameters specific to various actions are also determined. For example, parameters specific to a “view” action may be determined. Such parameters may indicate which specific instance of a target report is to be viewed, which specific part of a target report is to be viewed, which specific report is to be viewed if the target BI document contains multiple reports, if a refresh is to be forced once the target document is opened, prompts to be invoked, etc. In an embodiment, “prompt” may be an action part of a BI workflow, in response to which a message may be displayed to indicate that the computer system is ready to receive a command. For example, in a sales report, there may be a parameter that asks the user to choose a region. When the user chooses a region, the report may display the results for that specific region. In one embodiment, a parameter that indicates the format in which the target document is displayed may also be determined.

At 230, based on the determined parameters, the action of the BI workflow is encoded into URL. In one embodiment, a generator module (e.g., 140 in FIG. 1) constructs the URL. The generator may request a CMS (e.g., 150 in FIG. 1) to retrieve additional information such as user rights from a CMS Repository (e.g., 180 in FIG. 1). An example of a constructed URL that may represent an encoded action of a BI workflow may be represented as follows:
http://<hostname>:<port>/BOE/OpenDocument/opendoc/openDocument.jsp ?iDocID=5290&actionType=Schedule

At 240, in response to the request, the encoded action of the BI workflow is sent as output data. The generator may send the constructed URL to a generating system such as a job server (e.g., 120 in FIG. 1). In one embodiment, based on the constructed URL, an interpreter such as interpreter 130 (FIG. 1) launches the encoded action of the BI workflow. Another example of a system that may employ the constructed URL is a client application (e.g., 110 in FIG. 1) in which the interpreter is embedded. For example, a user may bookmark a “modify” action of settings of a specific report.

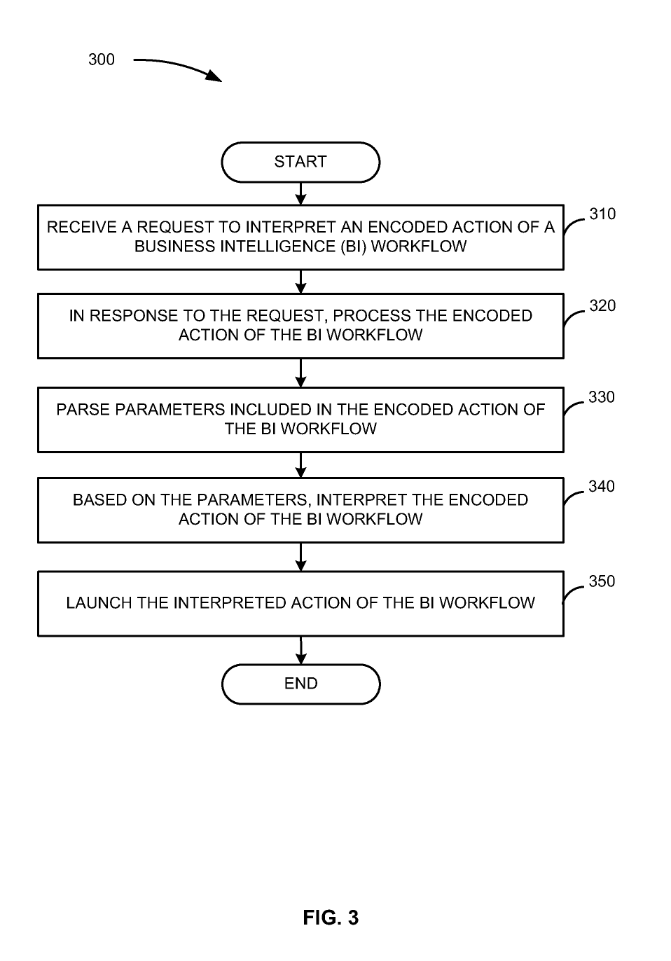

FIG. 3 illustrates a process 300 for interpreting an encoded action of a BI workflow in a BI computer system, according to one embodiment. At 310, a request to interpret an encoded action of a BI workflow is received. In one embodiment, the request is received at an interpreter module (e.g., 130 in FIG. 1). In one embodiment, the request may be invoking an URL representing the encoded action of the BI workflow. At 320, in response to the received request, the encoded action of the BI workflow is processed. In one embodiment, a user's credentials may be determined, for example, the user may authenticate to the BI computer system. In yet another embodiment, a single-sign on session may be set up. At 330, parameters included in the encoded action of the BI workflow are parsed. For example, parameters included in the URL may be retrieved. Based on the parsed parameters, at 340, the encoded action of the BI workflow is interpreted. The action to be launched is determined and context in which the action is to be launched is also determined. One or more parsed parameters may be passed in to the determined action. At 350, the interpreted action of the BI workflow is launched. For example, a client application (e.g., 110 in FIG. 1) may launch the interpreted action. In one embodiment, graphical user interface (GUI) associated with the encoded action of the BI workflow is rendered. For example, a modal dialog to reschedule a report may be launched by BI Launch pad and displayed in a browser application.

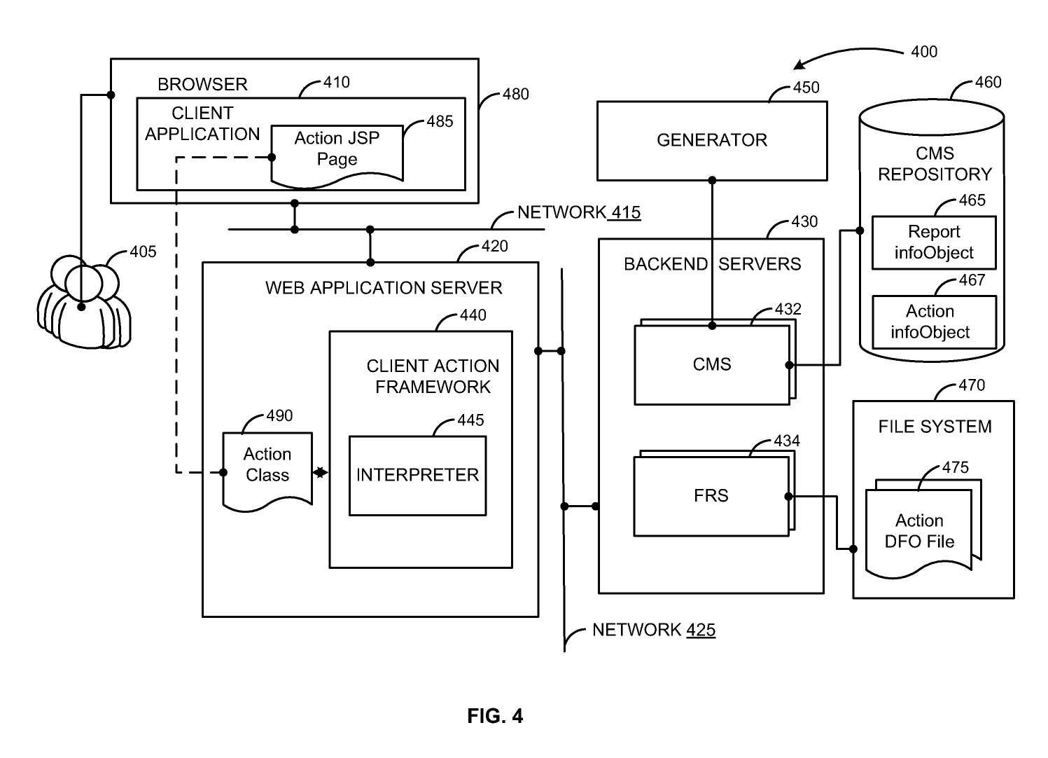

FIG. 4 illustrates exemplary system 400 in a context of a BI platform, where access to BI workflows is enabled, according to one embodiment. Users 405 may request different services or execute various operations available within client system 410 or provided by web application server 420 via network 415. Web application server 420 may interact with backend servers 430 via network 425 to provide and execute requested services and operations. In one embodiment, backend servers 430 include one or more servers such as File Repository Server (FRS) 434 and CMS 432. CMS 432 may query CMS repository 460 to retrieve information objects associated with BI entities on the BI platform. FRS 434 manages files stored on file system 470. In one embodiment, BI documents may be stored in file system 470. Some of the elements of system 400 resemble the structure and functionality of software modules part of SAP® BusinessObjects™ BI platform. However, other structures with similar functionalities could be found in software products developed by other vendors, as well. Alternative embodiments may utilize other kinds of computer system architectures.

Users 405 may access client application 410 via browser 480. In one embodiment, client application 410 may be a BI portal such as CMC, BI Launch pad or KMC. Users 405 may invoke actions by selecting GUI controls from client application 410. In one embodiment, actions implement a web page, e.g. Action JSP Page 485, which displays the actions' UIs to users 405. Actions may implement a class such as Java class 490. In one embodiment, class 490 interacts with the BI platform via Client Action Framework 440. Client Action Framework 440 provides functions and other application programming interfaces (APIs) for client application 410 to utilize available actions. An action's metadata may be included in the information object associated with the action, e.g., action infoObject 467. In one embodiment, Action JSP Page 485, Java class 490 and action infoObject 467 may implement the logic of the action with which they are associated. The metadata of the action may define the action's properties such as its name, client applications that may use it, type of the information object it can act upon, and an URL that locates the action's web page. Actions' information objects may be stored in CMS Repository 460. Metadata associated with information objects may be stored in Default Objects (DFOs) files. Default objects are information objects that provide basic functionality for the BI system. For example, CMS 432 uses DFO files to automatically create default objects at startup time. In one embodiment, metadata associated with action infoObject 467 may be included in action DFO file 475. FRS 434 may query file system 470 to retrieve DFOs files.

In one embodiment, a user from users 405 may invoke an encoded action of a BI workflow from client application 410. For example, the user may select a bookmark in browser 480 that is associated with the encoded action to invoke the action. In one embodiment, the action of the BI workflow is encoded by generator 450. Based on an URL representing the encoded action, interpreter 445 may determine an information object associated with the encoded action, an information object associated with a target BI document the action is to be launched against, and other context parameters. For example, interpreter 445 may send request to CMS 432 to retrieve action infoObject 467 from CMS Repository 460 and report infoObject 465 associated with the target report the action is to be launched against. Based on retrieved action infoObject 467, report infoObject 465, and other context parameters, action class 490 may initialize Action JSP Page 485. In response to the initialization of the Action JSP Page 485, the requested encoded action is launched. For example, GUI associated with the requested action is rendered.

In one embodiment, an action set may be used to combine actions into a BI workflow and display the combined actions as a logical unit. Action sets may specify an order in which actions, part of the action sets, are to be executed. Thus, action sets may be used to implement BI workflows. Metadata associated with an action set is contained in an information object of type “action set”. The information object of the action set contains reference to actions comprising the actions set. In one embodiment, actions included in an action set may be invoked independently. In yet another embodiment, actions included in an action set may be invoked in the context of a BI workflow associated with the action set. For example, a scheduling BI workflow may be represented by an information object “doSchedule” of type “action set”. The information object may contain reference to actions such as “get prompts” that may prompt the user to input further data, “get recurrence” may prompt the user to input recurrence settings of a scheduled report, and “set destination” may request from the user to determine an output destination of the scheduled report where the report is to be sent once generated.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

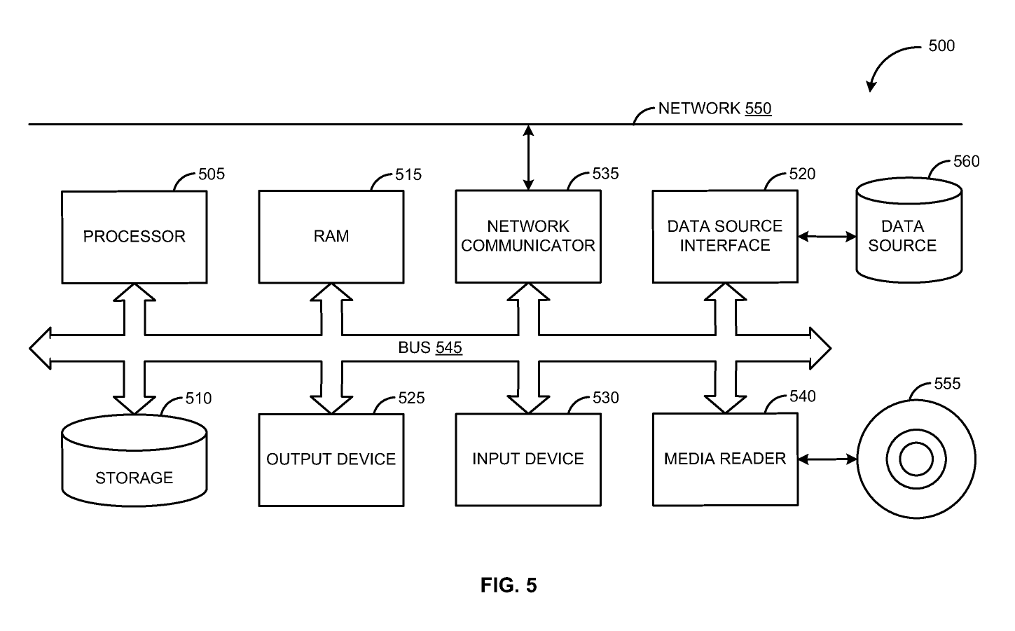

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to access an action of a workflow from a plurality of business intelligence (BI) workflows in a computer system, the method comprising:
receiving a request to access said action of said workflow, wherein said action of said workflow is encoded;
interpreting said encoded action of said workflow; and
in response to said request, launching by said computer said action of said workflow.

2. The method of claim 1, further comprising:
encoding said action of said workflow in generic syntax to identify and locate said action of said workflow.

3. The method of claim 2, wherein encoding said action of said workflow in generic syntax further comprises:
generating an Uniform Resource Locator (URL) associated with said action of said workflow.

4. The method of claim 1, further comprising:
encoding said action of said workflow based on context parameters associated with said action of said workflow.

5. The method of claim 1, wherein interpreting said encoded action of said workflow further comprises:
processing context parameters associated with said action of said workflow.

6. The method of claim 1, wherein launching said action of said workflow further comprises:
rendering graphical user interface associated with said requested action of said workflow.

7. The method of claim 1, wherein launching said action of said workflow further comprises:
launching said step of said workflow in a context associated with said step of said workflow.

8. A computer system to access an action of a workflow from a plurality of business intelligence (BI) workflows, the system including:
at least one processor and memory for executing program code, the program code related to:
a generator to encode said action of said workflow, said generator to receive request to encode said step of said workflow;
an interpreter to interpret said encoded action of said workflow, said interpreter to receive request to interpret said action of said workflow; and
launching said requested action of said workflow in response to request to access said action of said workflow.

9. The system of claim 8, wherein said generator encodes said action of said workflow in generic syntax to identify and locate said action of said workflow.

10. The system of claim 8, wherein said generator encodes said action of said workflow based on context parameters associated with said action of said workflow.

11. The system of claim 8, wherein said interpreter processes context parameters associated with said action of said workflow.

12. The system of claim 8, wherein said computer system renders a graphical user interface (GUI) associated with said requested action of said workflow.

13. The system of claim 8, wherein said computer system launches said action of said workflow in a context associated with said action of said workflow.

14. A non-transitory computer readable medium storing instructions thereon, which when executed by a processor cause a computer system to:
receive a request to access an action of a workflow from a plurality of business intelligence (BI) workflows, wherein said action of said workflow is encoded;
interpret said encoded action of said workflow; and
in response to said request, launch action of said workflow.

15. The computer readable medium of claim 14, further comprising:
encoding said action of said workflow in generic syntax to identify and locate said action of said workflow.

16. The computer readable medium of claim 14, encoding said action of said workflow in generic syntax further comprises:
generating an Uniform Resource Locator (URL) associated with said action of said workflow.

17. The computer readable medium of claim 14, further comprising:
encoding said action of said workflow based on context parameters associated with said action of said workflow.

18. The computer readable medium of claim 14, wherein interpreting said encoded action of said workflow further comprises:
processing context parameters associated with said action of said workflow.

19. The computer readable medium of claim 14, wherein launching said action of said workflow further comprises:
rendering graphical user interface associated with said requested action of said workflow.

20. The computer readable medium of claim 14, wherein launching said action of said workflow further comprises:
launching said step of said workflow in a context associated with said step of said workflow.
